(19) United States
(12) Patent Application Publication
(10) Pub. No.: US 2026/0108926 A1
(43) Pub. Date: Apr. 23, 2026

(54) SPENT BLEACHING EARTH DEACTIVATION

(71) Applicant: Diamond Green Diesel LLC, San Antonio, TX (US)

(72) Inventors: David Oliver Tate, Jr., New Orleans, LA (US); Tanner Lawrence, Norco, LA (US); Dustin C. Mire, Norco, LA (US); Brad Roccaforte, Norco, LA (US); Michael Philip Dobeck, Dacula, GA (US)

(73) Assignee: Diamond Green Diesel LLC, San Antonio, TX (US)

(21) Appl. No.: 19/360,604

(22) Filed: Oct. 16, 2025

Related U.S. Application Data
(60) Provisional application No. 63/708,619, filed on Oct. 17, 2024.

(51) Int. Cl. B09C 1/08; C09K 17/02

(52) U.S. Cl. CPC B09C 1/08; C09K 17/02

(57) ABSTRACT

Provided are compositions and methods for passivating spent bleaching earth (SBE). An alkali metal salt component including an alkali metal salt, such as sodium bicarbonate or sodium carbonate, is added to the SBE, thereby deactivating or passivating the SBE.

### PRIORITY CLAIM

This application claims the benefit of and priority to U.S. Provisional Patent Application No. 63/708,619, filed on Oct. 17, 2024, the entire contents of which is hereby incorporated by reference.

### TECHNICAL FIELD

The present invention relates generally to the field of passivating spent bleaching earth (SBE).

### BACKGROUND

Renewable diesel, consumable oils, or similar products can be made from a variety of feedstocks including, but not limited to, used cooking oils, animal byproducts, or various plant derived oils; however, the oil product may first be pretreated to meet the associated requirements for the downstream processes or consumption. Bleaching is a step that can be involved in the pretreatment process. The bleaching step serves to further improve the properties of the oil product by removing the undesirable components from the oil to meet certain specifications required for the oil product. This bleaching is not just in the renewable diesel application, but also in consumable oils or similar products. In the bleaching process, the oil comes into contact with an adsorbent at approximately 200° F. that can remove additional undesirable contaminants or impurities from the oil product. Bleaching earth (BE) is an example of an adsorbent that is used in the bleaching phase of the process. Bleaching earth may include, for example, bentonite, attapulgite, and/or sepiolite, or any other material useful for removing impurities from the oil. Bleaching earth may also include, for example, activated carbon and/or natural clays (kaolinite, palygorskite). Due to the bleaching earth being an adsorbent, it should be removed from the oil, resulting in spent bleaching earth (SBE) being produced.

SBE will naturally contain an elevated amount of contaminants such as metals and other impurities removed from the oil. SBE also contains residual oil material suspended in or coating the SBE particles. SBE may include about 10-50 wt. % or more typically about 20-40 wt. % residual oil. SBE is typically disposed of in a landfill, but due to the risk of increased temperatures or smoldering due to the oxidation of the residual oil material, there are high fees and potential hazards associated with the disposal of SBE.

Some techniques to prevent smoldering of SBE include wetting the SBE with water or the addition of acids and/or inert materials (e.g., fly ash, plant waste) to break down or stabilize the oil material or dilute the heating effect. Wetting the material with water reduces the temperature, but does little to reduce the overall amount of heat energy released by the breakdown of the residual oil material in the SBE. The addition of acids or inert materials can be expensive and can have additional ecological and sustainability concerns. Thus, there is an ongoing need for compositions and methods for deactivating or passivating SBE that are sustainable and economical.

### SUMMARY OF THE INVENTION

Provided herein are compositions and methods for passivating spent bleaching earth (SBE).

In an aspect, provided is a composition comprising an alkali metal salt and SBE, wherein when the alkali metal salt contacts the SBE, the SBE is passivated.

In another aspect, provided is a process for passivating SBE, the process comprising adding an alkali metal salt to the SBE, thereby passivating the SBE. In some embodiments, the alkali metal salt is added to the SBE as a dry powder. In some embodiments, the alkali metal salt is added to the SBE as an aqueous solution or a slurry.

In yet another aspect, provided is a process for passivating SBE, the process comprising: adding the SBE to a mixing apparatus, adding an alkali metal salt to the SBE in the mixing apparatus, and mixing the alkali metal salt and the SBE, where when the alkali metal salt contacts the SBE, the SBE is passivated. In some embodiments, the alkali metal salt is added to the SBE as a dry powder, an aqueous solution, or a slurry. In some embodiments, the alkali metal salt is added to the SBE while the SBE is added to the mixing apparatus.

In another aspect, provided is a process for passivating SBE, the process comprising: adding the SBE to a mixing apparatus, adding an alkali metal salt to water to form a slurry, adding the slurry to the SBE in the mixing apparatus, and mixing the slurry and the SBE, where when the alkali metal salt contacts the SBE, the SBE is passivated.

In some embodiments, the alkali metal salt is present in an amount from about 1.5 wt. % to about 7 wt. %, or from about 2.0 wt. % to about 4.0 wt. %, or from about 2.5 wt. % to about 3.5 wt. % compared to the total amount of the SBE.

In some embodiments, the alkali metal salt is a carbonate, a bicarbonate, or a mixture of two or more thereof. In some embodiments, the alkali metal salt is sodium bicarbonate. In some embodiments, the alkali metal salt is sodium carbonate.

Both the foregoing summary and the following brief description of the drawings and detailed description are exemplary and explanatory. They are intended to provide further details of the invention, but are not to be construed as limiting. Other objects, advantages, and novel features will be readily apparent to those skilled in the art from the following detailed description of the invention.

### BRIEF DESCRIPTION OF THE DRAWINGS

FIGS. 1A-1C are diagrams of processes of passivating or deactivating SBE.

FIG. 2 shows the set-up used for testing sodium bicarbonate as a means for deactivating SBE.

FIG. 3A shows the SBE-Commercially-available SBE passivation product dry dump and wet dump. Both had similar results on temperature. FIG. 3B shows the trailer containing the SBE and Commercially-available SBE passivation product mixture. Temperature readings were performed on the mixture in the trailer.

FIG. 4A shows the SBE-sodium bicarbonate dump. FIG. 4B shows the trailer containing the SBE and sodium bicarbonate mixture. Temperature readings were performed on the mixture in the trailer.

### DETAILED DESCRIPTION

### Overview

Spent bleaching earth (SBE) is a solid waste product created through the use of bleaching earth to refine oil. Bleaching earth is applied to renewable diesel and oil products (referred to herein as renewable oil products to remove impurities from the oil and to improve the color and odor of the product. SBE is a waste product in the production of these renewable oil products, as the, SBE is disposed of, often as landfill, or may be remediated for reuse.

During treatment of the oil, the bleaching earth becomes coated with or absorbs fat and oil materials such that the SBE includes a substantial amount of residual oil. For example, residual oil may make up as much as 50 wt. % of the total mass of SBE, with the amount of residual oil typically ranging from about 20 wt. % to about 40 wt. % of the total mass of the SBE. In certain conditions, such as a warm, oxygenating environment, the residual oil material in the SBE may undergo exothermic decomposition, causing it to smolder and to increase in temperature. Thus, SBE should be passivated to prevent exothermic decomposition of the residual oil as part of the waste disposal or remediation process.

### Compositions

The present invention provides compositions for passivating SBE, thereby reducing or preventing the exothermic decomposition of the residual oil contained therein.

In an aspect, provided are SBE mixture compositions comprising a mixture of SBE and an alkali metal salt component, the alkali metal salt component including one or more alkali metal salts.

Without wishing to limit the present invention to any theory or mechanism, it is believed that the alkaline metal salt reacts with the fat/phospholipid present in the SBE, thereby reducing the reactivity of the fat with oxygen, thereby deactivating or passivating the SBE. Additionally, the alkali salt may react with the underlying clay/minerals of the SBE, such as through chelation, reducing the oxidative potential of residual oil on the surface. As the alkaline metal salt reacts with the oil and other components of the SBE, carbon dioxide may be produced, further reducing the oxidation of the residual oil carried by the SBE.

The alkali metal salt component is present in the SBE mixture composition such that the alkali metal salt is at a concentration of about 1.0 wt. % to about 10 wt. % (i.e., 1 kg to 10 kg alkali metal salt per 100 kg of SBE), or from about 1.5 wt. % to about 7.0 wt. %, or from about 2.0 wt. % to about 6.0 wt. %, or from about 4.0 wt. % to about 6.0 wt. % or from about 4.5 wt. % to about 6.5 wt. %, or from about 5.0 wt. % to about 6.0 wt. %, compared to the total mass of the SBE. In some embodiments, the alkali metal salt component is added based on the amount of residual oil contained in the SBE.

Although specific examples follow, the alkali metal salt used in the alkali metal salt component is not limited to a particular species or composition. In some embodiments, the alkali metal salt in the alkali salt component is one or more of a metal salt of a carbonate, bicarbonate, or hydroxide. In some embodiments, the alkali metal salt is sodium bicarbonate, sodium carbonate, potassium acetate, sodium acetate, potassium phosphate, sodium phosphate, potassium bicarbonate, potassium carbonate, lithium hydroxide, potassium hydroxide, sodium hydroxide, or a combination of any two or more thereof.

In some embodiments, the alkali metal salt of the alkali metal salt component is sodium bicarbonate. Sodium bicarbonate is an alkaline salt that is mildly basic (about pH 8.5 in a 1 molar aqueous solution) and is established as safe to use (health 1, flammability 0, reactivity 0). In some embodiments, the alkali metal salt component is added to the SBE such that the sodium bicarbonate is present in the SBE mixture composition at an amount of at least about 3.0 wt. % compared to the total amount of the SBE (i.e., 3.0 kg sodium carbonate for 100 kg SBE). In some embodiments, the sodium bicarbonate is present in the SBE mixture composition at an amount of at least about 4.5 wt. % compared to the total mass of the SBE. In some embodiments, the sodium bicarbonate is present in the SBE mixture composition at an amount of about 1.5 wt. % to about 7.0 wt. %, or from about 2.0 wt. % to about 6.0 wt. %, or from about 4.0 wt. % to about 6.0 wt. % or from about 4.5 wt. % to about 6.5 wt. %, or from about 5.0 wt. % to about 6.0 wt. %, compared to the total mass of the SBE.

In some embodiments, the alkali metal salt is sodium carbonate. Sodium carbonate is an alkaline salt that is basic (about pH 11.5 in a 1 molar aqueous solution) and is safe to use (health 2, flammability 0, reactivity 1). In some embodiments, the sodium carbonate is present in the composition at an amount of at least about 1.5 wt. % compared to the total mass of the SBE (i.e., 1.5 kg sodium carbonate for 100 kg SBE). In some embodiments, the sodium carbonate is present in the composition at an amount of at least about 2.5 wt. % compared to the total amount of the SBE. In some embodiments, the sodium carbonate is present in the composition at an amount of at least about 3.5 wt. % compared to the total amount of the SBE. In some embodiments, the sodium carbonate is present in the composition at an amount ranging from about 1.5 wt. % compared to about 7.0 wt. %, or from about 2.5 wt. % to about 5.0 wt. % or from about 3.0 wt. % to about 4.0 wt. % of the total mass of the SBE.

In some embodiments, alkali metal salt component is added to the SBE as a dry powder to form the SBE mixture. The alkali metal salt component may be a substantially pure powder comprising mostly or substantially pure alkali metal salt. In some embodiments, the alkali metal salt is in another form, such as granules, crystals, etc. suitable for mixing with the SBE. In some embodiments, the alkali metal salt component comprises an alkali metal salt that is diluted with another material, such as soda ash, fly ash, talc, clay, agricultural byproducts (such as dried and ground corn cobs, rice hulls, wheat hulls, nut shells, saw dust, coconut husks, etc.), sand, silica, alumina, clay, or another material.

In some embodiments, the alkali metal salt component is added in a liquid or slurry form. In some embodiments, an alkali metal salt is mixed with water to form a slurry or solution before the alkali metal salt component is added to the SBE. In some embodiments, the water and alkali metal salt are added to the SBE at the same time or in the same process unit/step, such that the alkali metal salt and water are mixed with the SBE together.

### Methods

The present invention further provides methods for passivating SBE.

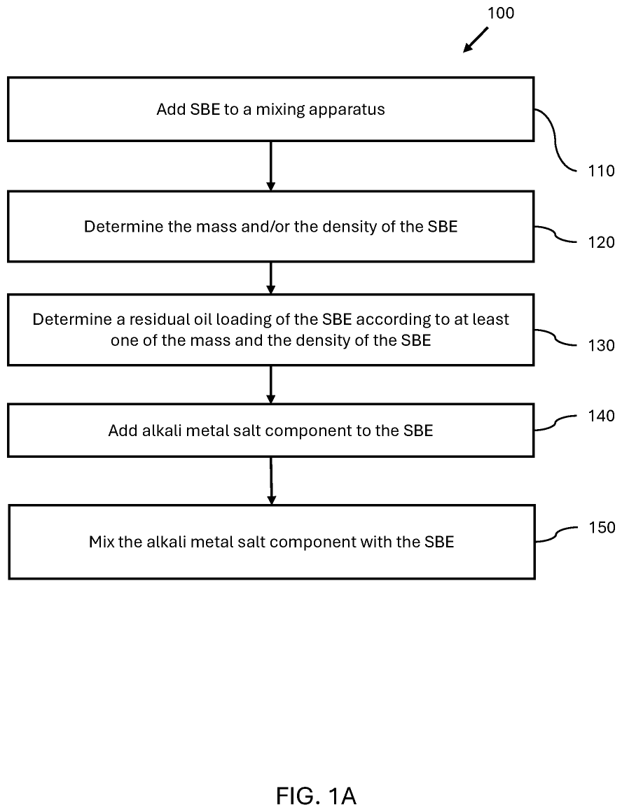

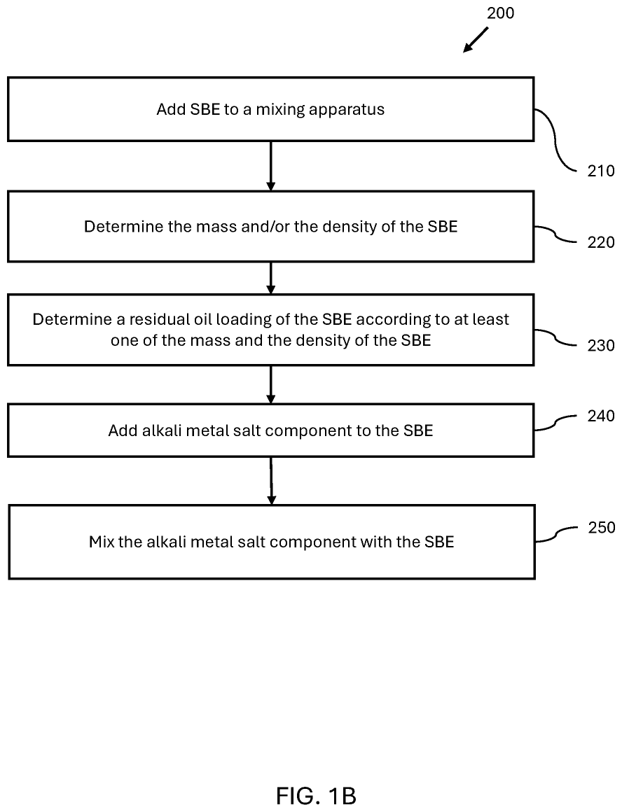

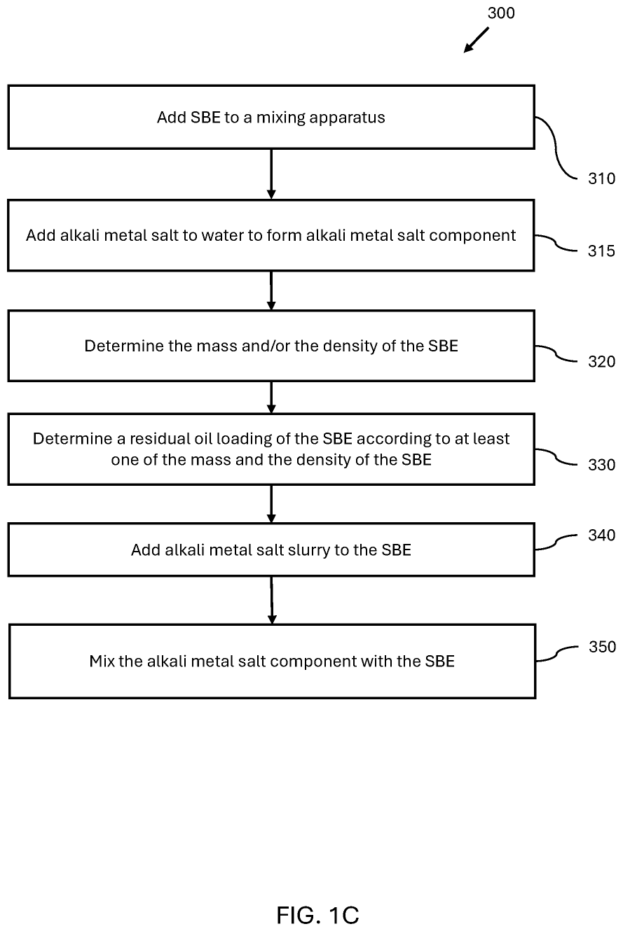

As illustrated in FIG. 1A, in an aspect, a method 100 comprises a step 140 of adding an alkali metal salt component to the SBE. The method 100 may also one or more optional steps, such as a step 110 of adding the SBE to a mixing apparatus, a step 120 of determining the mass and/or the density of the SBE, a step 130 of determining the residual oil loading of the SBE according to one or more of the mass and the density of the SBE, and a step 150 of mixing the alkali metal component with the SBE. The steps need not be performed in a particular order. The method 100 may include adding the alkali metal salt component to the SBE before adding the SBE to the mixing apparatus or may include adding the alkali metal salt component to the SBE while the SBE is in the mixing apparatus. In some embodiments, the alkali metal salt component is added to the mixing apparatus and the step 150 of adding the alkali salt component to the SBE is performed by adding the SBE to the mixing apparatus.

As illustrated in FIG. 1B, in some embodiments, the method 200 comprises: a step 210 of adding the SBE to a mixing apparatus, a step 240 of adding an alkali metal salt component to the SBE in the mixing apparatus, and a step 250 of mixing the alkali metal salt component and the SBE, where the alkali metal salt component includes one or more alkali metal salts. In some embodiments, the mixing apparatus is one or more of a ribbon blender, a v-blender, a cone blender, a double cone blender, a tumble blender, a fluidized bed mixer, a bladed mixer, a paddle mixer, a planetary mixer, and/or a static mixer. The method 200 may optionally include a step 220 of determining a mass or density of the SBE and/or a step 230 of determining a residual oil loading of the SBE according to the mass and/or density of the SBE.

As illustrated in FIG. 1C, in some embodiments, the method 300 comprises: a step 310 of adding the SBE to a mixing apparatus, a step 320 adding an alkali metal salt to water to form a slurry, 340 of adding the slurry, which serves as the alkali metal salt component, to the SBE in the mixing apparatus, and a step 350 of mixing the slurry and the SBE. In some embodiments, the alkali metal salt and the water are added to the SBE in the same process unit/step such that the alkali metal salt and water forms a slurry while being mixed with the SBE. In some embodiments, the mixing apparatus is one or more of a ribbon blender, a v-blender, a cone blender, a double cone blender, a tumble blender, a fluidized bed mixer, a bladed mixer, a paddle mixer, a planetary mixer, and/or a static mixer. The method 300 may optionally include a step 320 of determining a mass or density of the SBE and/or a step 330 of determining a residual oil loading of the SBE according to the mass and/or density of the SBE.

Although specific examples follow, the alkali metal salt used in the alkali metal salt component is not limited to a particular species or composition. In some embodiments, the alkali metal salt in the alkali salt component is one or more of a metal salt of a carbonate, bicarbonate, or hydroxide. In some embodiments, the alkali metal salt is sodium bicarbonate, sodium carbonate, potassium acetate, sodium acetate, potassium phosphate, sodium phosphate, potassium bicarbonate, potassium carbonate, lithium hydroxide, potassium hydroxide, sodium hydroxide, or a combination of any two or more thereof.

In some embodiments, the alkali metal salt is any alkali metal salt described herein. In some embodiments, the alkali metal salt component is added to the SBE such that an amount of alkali metal salt ranges from about 1.0 wt. % to about 10.0 wt. %, or from about 1.5 wt. % to 7.0 wt. %, or from about 2.0 wt. % to about 6.0 wt. %, or from about 4.0 wt. % to about 6.0 wt. % or from about 4.5 wt. % to about 6.5 wt. %, or from about 5.0 wt. % to about 6.0 wt. %, compared to the total mass of the SBE. In some embodiments, the alkali metal salt component is added to the SBE such that an amount of alkali metal salt ranges from about 0.5 wt. % to about 5.0 wt. %, or from about 0.0.7 wt. % to 3.5 wt. %, or from about 1.0 wt. % to about 3.0 wt. %, or from about 2.0 wt. % to about 3.0 wt. % or from about 2.2 wt. % to about 3.2 wt. %, or from about 2.5 wt. % to about 3.0 wt. %, compared to the total mass of the residual oil contained in the SBE.

In some embodiments, the alkali metal salt of the alkali metal salt component is sodium bicarbonate. Sodium bicarbonate is an alkaline salt that is mildly basic (about pH 8.5 in a 1 molar aqueous solution) and is established as safe to use (health 1, flammability 0, reactivity 0). In some embodiments, the alkali metal salt component is added to the SBE such that the sodium bicarbonate is present in the SBE mixture composition at an amount of at least about 3.0 wt. % compared to the total amount of the SBE (i.e., 3.0 kg sodium carbonate for 100 kg SBE). In some embodiments, the sodium bicarbonate is present in the SBE mixture composition at an amount of at least about 4.5 wt. % compared to the total mass of the SBE. In some embodiments, the sodium bicarbonate is present in the SBE mixture composition at an amount of about 1.5 wt. % to about 7.0 wt. %, or from about 2.0 wt. % to about 6.0 wt. %, or from about 4.0 wt. % to about 6.0 wt. % or from about 4.5 wt. % to about 6.5 wt. %, or from about 5.0 wt. % to about 6.0 wt. %, compared to the total mass of the SBE.

In some embodiments, the alkali metal salt is sodium carbonate. Sodium carbonate is an alkaline salt that is basic (about pH 11.5 in a 1 molar aqueous solution) and is safe to use (health 2, flammability 0, reactivity 1). In some embodiments, the sodium carbonate is present in the composition at an amount of at least about 1.5 wt. % compared to the total mass of the SBE (i.e., 1.5 kg sodium carbonate for 100 kg SBE). In some embodiments, the sodium carbonate is present in the composition at an amount of at least about 2.5 wt. % compared to the total amount of the SBE. In some embodiments, the sodium carbonate is present in the composition at an amount of at least about 3.5 wt. % compared to the total amount of the SBE. In some embodiments, the sodium carbonate is present in the composition at an amount ranging from about 1.5 wt. % compared to about 7.0 wt. %, or from about 2.5 wt. % to about 5.0 wt. % or from about 3.0 wt. % to about 4.0 wt. % of the total mass of the SBE.

In some embodiments, the alkali metal salt is added to the SBE as a dry powder (or other dry or particulate material), an aqueous solution, or a slurry. In some embodiments, the alkali metal salt component is a mixture of an alkali metal salt as described herein and other material, such as soda ash, fly ash, talc, clay, agricultural byproducts (such as dried and ground corn cobs, rice hulls, wheat hulls, nut shells, saw dust, coconut husks, etc.), sand, silica, alumina, clay, or another material. In embodiments where the alkali metal salt is added to the SBE as a dry powder, the method may further comprise adding water to the mixture of SBE and the alkali metal salt after the alkali metal salt is added to the SBE.

In embodiments where the alkali metal salt is added to the SBE as a slurry or solution, the amount of water added to the mixture of SBE may be a portion of the total mass of the SBE. In some embodiments, the amount of water is from about 0.5 wt. % to about 15 wt. % of the total mass of SBE. In some embodiments, the amount of water is from about 0.5 wt. % to about 7.5 wt. %, or from about 1.0 wt. % to about 6.0 wt. %, or from about 0.5 wt. % to about 3.0 wt. %, or from about 2.5 wt. % to about 5.0 wt. %, or from about 0.5 wt. % to about 2.0 wt. %, based on the total mass of SBE. In some embodiments, the amount of water added to the mixture of SBE is based on the mass of the alkali metal salt added. In some embodiments, the mass ratio of alkali metal salt to water is from about 10 to about 0.5, or from about 5 to about 1, or from 3 to about 1, or from 2 to about 1.

In some embodiments, the method includes a step 120 220 320 of determining the mass and/or the density of the SBE before adding the alkali metal salt component. The mass of the SBE may be determined by measuring the mass of the SBE or may be data that is retrieved from a database or received from an a data source. The mass of the SBE may be measured using, for example, scales and/or load sensors in a mixing unit. For example, in some embodiments, the SBE and alkali metal salt is mixed in a ribbon blender or other mixing unit equipped with load sensors. The load sensors provide the weight or mass of the SBE added to the mixing unit and the amount of alkali metal salt component (e.g., alkali metal salt and water) to be added is determined based on the indicated SBE mass. In other embodiments, the mass of the SBE is determined by querying a database or other data source for the SBE mass.

In some embodiments, the method includes a step 120 220 320 of determining the density of the SBE before adding the alkali metal salt. The density of the SBE may be determined by measuring the SBE mass and the volume occupied by the SBE mass, or may be determined by receiving the density of the SBE from a database of other data source. Measuring the mass of the SBE may be performed using, for example, load sensors in a mixing unit and measuring the volume of the SBE in the mixing unit. The volume occupied by the mass of SBE may be determined by knowing the volume of a storage container or by knowing the volume of the mixing unit. For example, in some embodiments, the SBE and alkali metal salt is mixed in a ribbon blender or other mixing unit equipped with load sensors. The load sensors provide the weight or mass of the SBE added to the mixing unit and the volume of a mixing chamber of the mixing unit may be known or may provide an indication of the volume contained therein.

In some embodiments, the methods 100 200 300 include a step 130 230 330 of determining a residual oil loading of the SBE. The density of the SBE may be correlated to a mass of oil carried by the SBE. For example, knowing the density of fresh BE, the density of the SBE, and an approximate density of the residual oil will allow for the determination of the loading of residual oil on the bleaching earth material (e.g., the mass of residual oil per unit mass of SBE or the mass fraction of residual oil in the SBE, which can be used to determine a total mass or volume of residual oil in the SBE). The amount of alkali metal salt component (e.g., alkali metal salt and water) to be added can then be determined based on the determined SBE density, the residual oil loading of the SBE, and/or mass of oil carried by the SBE. In such situations, the total amount of alkali metal salt may be adjusted based on the density to account for the amount of mass of oil carried by the SBE. In some embodiments, the method comprises determining the residual oil loading of SBE and preparing an alkali metal salt component sufficient to passivate the SBE.

In some embodiments, the addition of the alkali metal salt component to the SBE results in a decrease in the temperature of the SBE. In some embodiments, the addition of the alkali metal salt component to the SBE results in a decrease in the temperature of the SBE after disposal of the SBE. In some embodiments, the addition of the alkali metal salt component to the SBE results in a decrease in the temperature of the SBE 10-30 hours or 20-30 hours after disposal of the SBE compared to an SBE sample not treated with the alkali metal salt. In some embodiments, the additional of the alkali metal salt component to the SBE results in a reduced oxidation rate of the residual oil in the SBE. In some embodiments, the addition of the alkali metal salt component to the SBE prevents smoldering or spontaneous combustion of the SBE.

### Definitions

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, comparative terms as used herein, such as higher, lower, increase, decrease, reduce, or any grammatical variation thereof, can refer to certain variation from the reference. In some embodiments, such variation can refer to about 10%, or about 20%, or about 30%, or about 40%, or about 50%, or about 60%, or about 70%, or about 80%, or about 90%, or about 1 fold, or about 2 folds, or about 3 folds, or about 4 folds, or about 5 folds, or about 6 folds, or about 7 folds, or about 8 folds, or about 9 folds, or about 10 folds, or about 20 folds, or about 30 folds, or about 40 folds, or about 50 folds, or about 60 folds, or about 70 folds, or about 80 folds, or about 90 folds, or about 100 folds or more higher than the reference. In some embodiments, such variation can refer to about 1%, or about 2%, or about 3%, or about 4%, or about 5%, or about 6%, or about 7%, or about 8%, or 0%, or about 10%, or about 20%, or 30%, or 40%, or 50%, or 60%, or 70%, or 75%, or 80%, or 85%, or 90%, or about 95%, or about 96%, or about 97%, or about 98%, or about 99% of the reference.

“Optional” or “optionally” means that the subsequently described circumstance may or may not occur, so that the description includes instances where the circumstance occurs and instances where it does not.

As used herein, “and/or” refers to and encompasses any and all possible combinations of one or more of the associated listed items, as well as the lack of combinations when interpreted in the alternative (“or”).

Various embodiments are described herein. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

The present invention, thus generally described, will be understood more readily by reference to the following examples, which are provided by way of illustration and are not intended to be limiting of the present invention.

### Examples

### Test 1: Comparison of Sodium Bicarbonate and a Commercially-Available SBE Passivation Product as a Means of Deactivating SBE

The efficacy of sodium bicarbonate was evaluated as a means of deactivating SBE and was compared with a commercially-available SBE passivation product.

The following procedure was carried out for Test 1 with sodium bicarbonate:
1) The commercially-available SBE passivation product and water injection into the mixer was stopped for the duration of the test. However, when possible, the commercially-available SBE passivation product and water injection was continued to run on the other unit train for direct comparison.
2) Empty trucks were placed under the ribbon blender of both trains.
3) Once the conveyer completed dumping into the ribbon blender, measured amounts of sodium bicarbonate and water were added into the ribbon blender, and the amounts were recorded.
4) The ribbon blend was dumped, and the system was prepared for the next addition of sodium bicarbonate. There was approximately 45 mins between ribbon blender dumps, and this procedure continued for a total of 15 dumps or when the day has been completed (whichever came first).

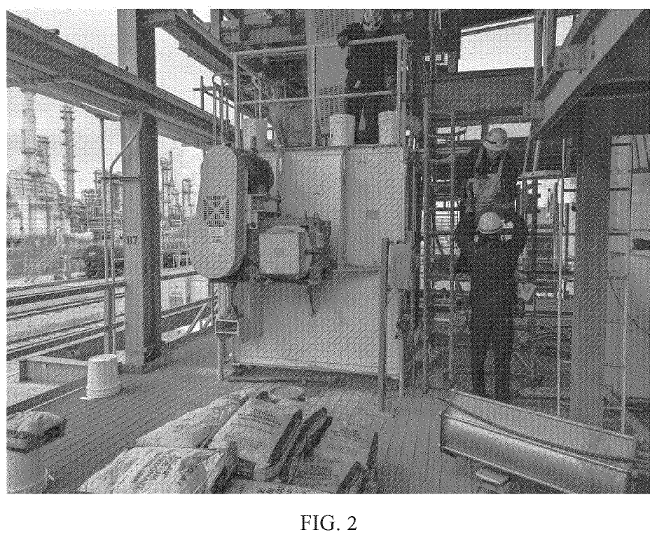

The sodium bicarbonate was placed on the deck near the ribbon blenders and a scaffolding was erected allowing for the bags to be lifted to the platform and dumped into the ribbon blender. The setup can be seen in FIG. 2. The blend fed to the unit for Test 1 was a composite of used cooking oil, corn oil, soybean oil, tallow, yellow grease, poultry fat, and fish oil.

The morning of Test 1, the commercially-available SBE passivation product was stopped for Train 2, and sodium bicarbonate was used instead, targeting 5% sodium bicarbonate and 5% water via the ribbon blender load cells. Table 1 below shows a summary of the sodium bicarbonate addition with the load cell readings.

TABLE 1
Sodium bicarbonate addition with the load cell readings.

| | RIBBON | | PERCENTAGE | | |
|---|---|---|---|---|---|
| | BLEND | DELTA | WATER | BAGS OF | GALLONS |
| | READING | WEIGHT | AND SODIUM | BICARBONATE | OF WATER |
| TIME | (LBS.) | (LBS.) | CARBONATE (%) | (50 LB./BAG) | (GAL.) |
| 7:40 | −750 | | | Ribbon Blend Dump | |
| 7:52 | 1370 | 2120 | 5.2% | 2 | 12 |
| 9:20 | 3983 | 2613 | 4.1% | 2 | 12 |
| 9:40 | −750 | | | Ribbon Blend Dump | |
| 10:25 | 1656 | 2406 | 4.5% | 2 | 12 |
| 10:32 | −735 | | | Ribbon Blend Dump | |
| 11:08 | 1083 | 1818 | 6.2% | 2 | 12 |
| 11:20 | −740 | | | Ribbon Blend Dump | |
| 12:04 | 1246 | 1986 | 5.6% | 2 | 12 |
| 12:11 | −740 | | | Ribbon Blend Dump | |
| 12:44 | 772 | 1512 | 7.6% | 2 | 12 |
| 12:54 | −770 | | | Ribbon Blend Dump | |
| 13:42 | 1116 | 1886 | 5.9% | 2 | 12 |
| 13:58 | −630 | | | Ribbon Blend Dump | |
| 15:00 | 1502 | 2132 | 5.2% | 2 | 12 |

| | | |
|---|---|---|
| 15:07 | −700 | Ribbon Blend Dump |

| | |
|---|---|
| Average: | 5.5% |

During Test 1, there was no smoldering seen anywhere in the trailers. This may have been due to the cool weather during the test. The highs were in the upper 70s (° F.) with lows in the lower 50s (° F.).

Both the commercially-available SBE passivation product (“Commercially available”) and sodium bicarbonate were added to the SBE in similar amounts with similar results in the pH and moisture content. The results of each can be seen in Table 2 below.

TABLE 2
Wt. % additions with resulting pH and moisture content.

| | | | | | Orig- | 100% |
|---|---|---|---|---|---|---|
| | Wt. % | Wt. % | Sample | Moisture | inal | material |
| | addition | water | pH | Content | pH | pH |
| Sodium | 5.5 | 5.5 | 7.5 | 3.79 | 4.8 | 8.5 |
| Bicarbonate | | | | | | |
| Commercially | 5.5 | 5.2 | 7.8 | 4.26 | 4.8 | 11.5 |
| Available | | | | | | |

While the commercially-available SBE passivation product has a pH of 11.5, it contains only 25-40 wt. % of the active ingredient. By contrast, sodium bicarbonate has a lower pH of 8.3, but is used as 100% of the active ingredient. In both cases, water was added to allow for the salt/treatment to dissociate, leading to saponification. The addition of water also has the added benefit of evaporative cooling as it sits.

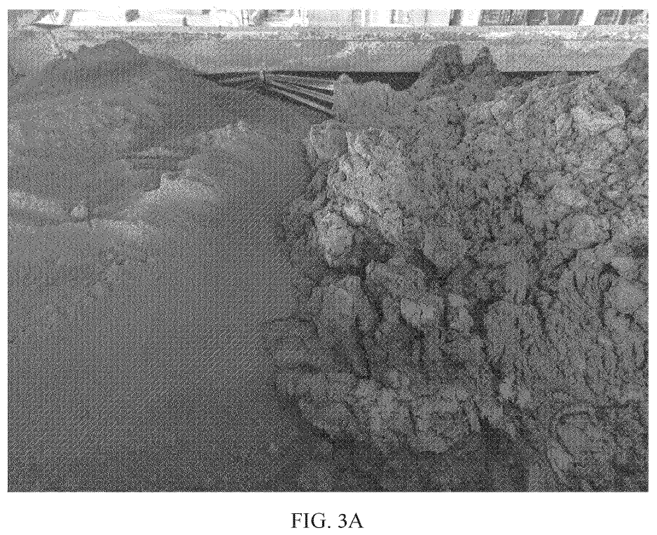

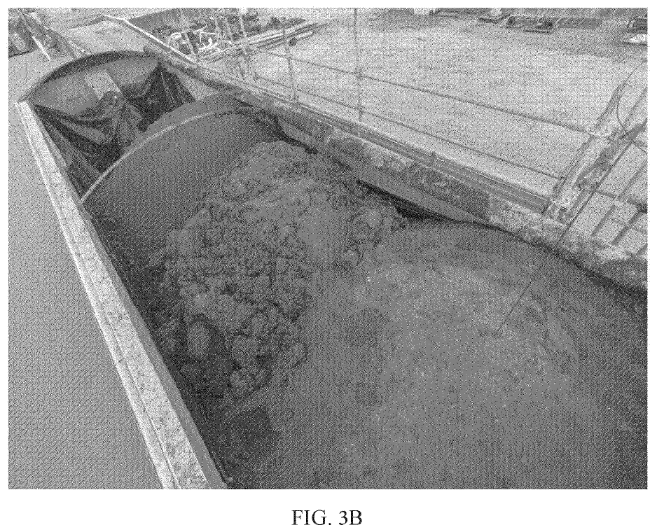

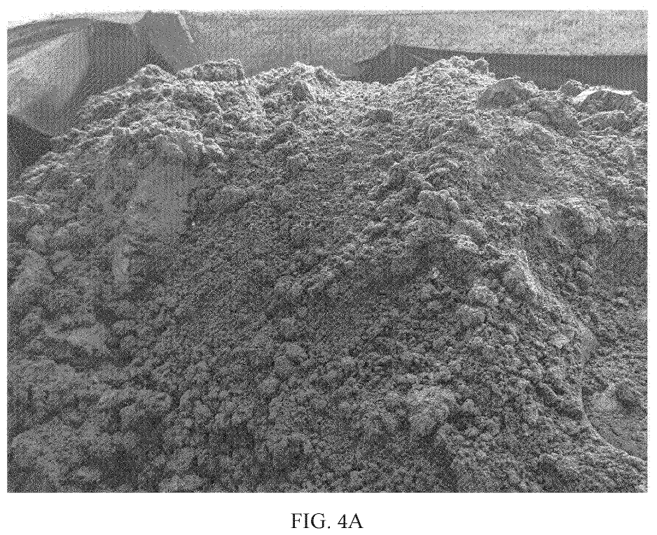

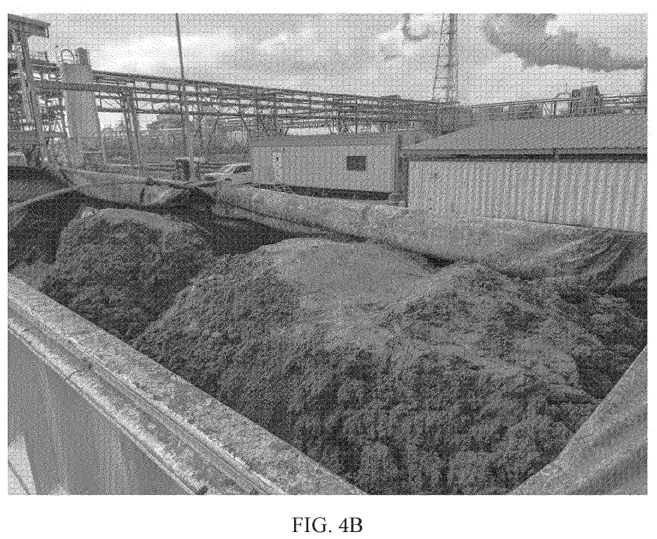

The differences between the use of sodium bicarbonate and the commercially-available SBE passivation product were observed when the trailers were set to the side (FIGS. 3A-4B), and the temperatures were monitored. The temperature of the material entering the ribbon blend is approximately 155° F., and the temperature at the time of the dump is approximately 150° F. On average, the SBE mixed with sodium bicarbonate was 33° F. cooler at the middle of the trailer (2 ft depth) compared to the SBE mixed with the commercially-available SBE passivation product on day 6, a 33° F. difference between the two mixtures was observed on day 7, a 29° F. difference was observed on day 8, and a 23° F. difference was observed on day 11 (day 0 being the time of addition, Tables 3-4). All of these samples were taken within a few inches of each other in the center of the trailer for consistency between days. An 8-foot k-type temperature probe was used along with a fluke 714 thermocouple calibrator for reading the temperature. Once the temperature at each respective depth had stabilized, the temperature was recorded. Tables 3 and 4 show the temperature results for each trailer.

TABLE 3
SBE mixed with sodium bicarbonate temperature
readings in ° F. at a range of pile depths during Test 1.
Sodium Bicarbonate - Temperature Reading (° F.)

| | | | | | | | | Sample | | | Days |
|---|---|---|---|---|---|---|---|---|---|---|---|
| Top | 1 ft | 1.5 ft | 2 ft | 2.5 ft | 3 ft | 4 ft | Bot | Time | Temp. | Condition | After |
| | 100.8 | | 103.5 | | 96.1 | 78.1 | | 14:30 | 61° F. | Sunny | 6 |
| | 92.0 | | 98.3 | | 92.7 | 77.5 | | 14:45 | 61° F. | Sunny | 6 |
| 102.3 | 99.2 | | 102.7 | | 90.2 | 75.4 | 75.9 | 15:00 | 61° F. | Sunny | 6 |
| 102.3 | 97.3 | | 101.5 | | 93.0 | 77.0 | 75.9 | average | 61° F. | Sunny | 6 |
| 67.1 | 96.2 | | 100.7 | | 92.6 | 72.8 | 65 | 8:00* | 56° F. | Overcast* | 7 |
| 69.3 | 91.9 | 94.6 | 96.8 | 97.1 | 90.4 | 77.4 | 72.2 | 8:00* | 68° F. | Overcast* | 8 |
| 59.7 | 85.8 | 88.4 | 89.8 | 88.5 | 85.3 | 73.5 | 59.7 | 6:45* | 58° F. | Overcast* | 11 |

*0.5-1.5 hours after sunrise

TABLE 4
SBE mixed with Commercially-available SBE passivation
product temperature readings during Test 1.
Commercially-available Product - Temperature Reading (° F.)

| | | | | | | | | Sample | | | Days |
|---|---|---|---|---|---|---|---|---|---|---|---|
| Top | 1 ft | 1.5 ft | 2 ft | 2.5 ft | 3 ft | 4 ft | Bot | Time | Temp. | Condition | After |
| | 128.7 | | 137.8 | | 128.7 | 100.3 | | 15:15 | 61° F. | Sunny | 6 |
| | 127.0 | | 133.5 | | 114.5 | 82.7 | | 15:30 | 61° F. | Sunny | 6 |
| 107.0 | 132.8 | | 131.1 | | 111.1 | 80.7 | 79.0 | 15:45 | 61° F. | Sunny | 6 |
| 107.0 | 129.5 | | 134.1 | | 118.1 | 87.9 | 79.0 | average | 61° F. | Sunny | 6 |
| 69.1 | 124.4 | | 133.4 | | 121.4 | 92.2 | 68.1 | 8:15* | 56° F. | Overcast* | 7 |
| 73.7 | 117.3 | 126.2 | 126.5 | 125.6 | 116.1 | 92.8 | 74.7 | 8:15* | 68° F. | Overcast* | 8 |
| 63.0 | 86.3 | 104.2 | 111.7 | 113.2 | 113.7 | 108.7 | 66.5 | 7:00* | 58° F. | Overcast* | 11 |

*0.75-1.75 hours after sunrise

While the smoldering issue was not observed during Test 1, there was a large difference seen between the peak temperatures of the SBE mixed with the commercially-available SBE passivation product and SBE mixed with sodium bicarbonate. The SBE mixed with sodium bicarbonate was consistently about 33-30° F. lower over the course of several days. Due to temperature readings not being recorded until day 6, the test was repeated and the temperatures were monitored throughout the process.

### Test 2: Comparison of Sodium Bicarbonate and a Commercially-Available SBE Passivation Product as a Means of Deactivating SBE

The procedure used for Test 2 was the same as the procedure used in Test 1. The commercially-available SBE passivation product was the same as used in Test 1. The blend being fed to the unit for Test 2 was similar to the initial test, and the metals pickup by the bleaching earth is shown in Table 5:

TABLE 5
Metals picked up by the Bleaching Earth per train.

| | P | Ca | Mg | Fe | Na | K | Si | Al | Total |
|---|---|---|---|---|---|---|---|---|---|
| PT Train 1 | | | | | | | | | |
| Water Wash | 92.5 | 5.2 | 1.3 | 3.4 | 1.8 | 4.4 | 1.2 | 0.8 | 110.6 |
| Refined Oil | 26.8 | 4.2 | 2.6 | 2.2 | 5.1 | 4.6 | 0.5 | 1.9 | 47.9 |
| Metals Delta | 65.7 | 1.0 | — | 1.2 | — | — | 0.7 | — | 68.6 |
| PT Train 2 | | | | | | | | | |
| Water Wash | 47.0 | 4.8 | 0.8 | 2.3 | 7.2 | 2.5 | 3.8 | <0.5 | 68.4 |
| Refined Oil | 6.2 | 1.6 | <0.5 | <0.5 | 6.3 | 1.3 | 1.6 | <0.5 | 17.0 |
| Metals Delta | 40.8 | 3.2 | 0.3 | 1.8 | 0.9 | 1.2 | 2.2 | — | 50.4 |

The morning of Test 2, the commercially-available SBE passivation product was stopped for Train 2, and sodium bicarbonate was used instead, targeting 5% sodium bicarbonate and 5% water via the ribbon blender load cells. Table 6 below shows a summary of the sodium bicarbonate addition with the load cell readings.

TABLE 6
Sodium bicarbonate addition with the load cell readings.

| | RIBBON | | PERCENTAGE | | |
|---|---|---|---|---|---|
| | BLEND | DELTA | WATER | BAGS OF | GALLONS |
| | READING | WEIGHT | AND SODIUM | BICARBONATE | OF WATER |
| TIME | (LBS.) | (LBS.) | CARBONATE (%) | (50 LB./BAG) | (GAL.) |
| 7:19 | 1536 | | | Ribbon Blend Dump | |
| 7:59 | 2937 | 1401 | 7.1% | 2 | 12 |
| 8:09 | 4390 | 1453 | 6.9% | 2 | 12 |
| 8:37 | 1573 | | | Ribbon Blend Dump | |
| 9:03 | 3955 | 2382 | 4.2% | 2 | 12 |
| 9:40 | 1781 | | | Ribbon Blend Dump | |
| 10:03 | 4256 | 2475 | 4.0% | 2 | 12 |
| 10:13 | 1600 | | | Ribbon Blend Dump | |
| 10:35 | 3937 | 2337 | 4.3% | 2 | 12 |
| 11:06 | 1606 | | | Ribbon Blend Dump | |
| 11:18 | 3730 | 2124 | 4.7% | 2 | 12 |
| 11:39 | 1461 | | | Ribbon Blend Dump | |
| 12:07 | 3712 | 2251 | 4.4% | 2 | 12 |
| 12:42 | 1690 | | | Ribbon Blend Dump | |
| 13:06 | 4763 | 3073 | 3.3% | 2 | 12 |
| 13:24 | 1622 | | | Ribbon Blend Dump | |
| 13:57 | 3616 | 1994 | 5.0% | 2 | 12 |
| 15:17 | 1552 | | | Ribbon Blend Dump | |
| 15:31 | 3122 | 1570 | 6.4% | 2 | 12 |

| | | |
|---|---|---|
| 15:50 | 1558 | Ribbon Blend Dump |

| | |
|---|---|
| Average: | 5.5% |

During Test 2, there was no smoldering seen anywhere in the trailers. This may have been due to the cool weather during the test. The high got up to 81° F. with a low of 52° F. with some rain two of the nights.

Commercially-available SBE passivation product (“Commercially Available”) and sodium bicarbonate were added to SBE in similar amounts with differences in the pH and moisture content (Table 7).

TABLE 7
Wt. % additions with resulting pH and moisture content

| | | | | | Orig- | 100% |
|---|---|---|---|---|---|---|
| | Wt. % | Wt. % | Sample | Moisture | inal | material |
| | addition | water | pH | Content | pH | pH |
| Sodium | 5.03 | 5.03 | 7.55 | 5.17 | 4.34 | 8.5 |
| Bicarbonate | | | | | | |
| Commercially | 6.34 | 6.34 | 9.08 | 7.21 | 4.34 | 11.5 |
| Available | | | | | | |
| Control | — | | 4.34 | 1.93 | 4.34 | — |

Trailers containing a mixture of SBE with sodium bicarbonate and SBE with the commercially-available SBE passivation product were set to the side, and the temperatures were monitored. In Test 2, the material entering the ribbon blend was approximately 160° F., and the temperature at the time of the dump was approximately 155° F. The SBE with sodium bicarbonate continually decreased in temperature down to 112° F. on day 7, whereas the SBE with the commercially-available SBE passivation product increased steadily to a peak of 175.5° F. on day 7. The delta peak temperature between the two mixtures ranged from 32° F. on day 1 to 63.5° F. on day 7. All of these samples were taken within a few inches of each other in the center of the trailer for consistency between days. An 8-foot k-type temperature probe was used along with a fluke 714 thermocouple calibrator for reading the temperature. Once the temperature at each respective depth had stabilized, the temperature was recorded. Table 8 summarizes the results for each trailer along with the comparative peak temperatures on a daily basis. Tables 9 and 10 show the temperature readings of each mixture.

TABLE 8
Daily comparative peak temperatures of SBE with sodium
bicarbonate (BS) and SBE with the commercially-available
SBE passivation product (“Commercially Available”).

| | Profix Peak | BS Peak | Peak dT BS vs |
|---|---|---|---|
| Days | Temperature | Temperature | Commercially Available |
| After | (° F.) | (° F.) | Temperature (° F.) |
| 1 | 167.2 | 135.0 | 32.2 |
| 2 | 168.8 | 132.7 | 36.1 |
| 3 | 174.0 | 129.5 | 44.5 |
| 4 | 172.4 | 124.7 | 47.7 |
| 7 | 175.5 | 112.0 | 63.5 |

TABLE 9
SBE mixed with sodium bicarbonate temperature readings during Test 2.
Sodium Bicarbonate - Temperature (° F.)

| | | | | | | | | | Sample | Days |
|---|---|---|---|---|---|---|---|---|---|---|
| Top | 0.5 ft | 1.0 ft | 1.5 ft | 2.0 ft | 2.5 ft | 3.0 ft | 4.0 ft | Bot | Time | After |
| 75.2 | | 130.0 | 134.0 | 135.0 | 132.1 | 128.7 | 112.1 | 79.5 | 8:30 | 1 |
| 75.2 | | 125.5 | 129.9 | 131.1 | 131.1 | 128.9 | 97.6 | 81.5 | 8:45 | 1 |
| 74.3 | | 116.2 | 125.6 | 128.5 | 127.4 | 122.6 | 92.5 | 79.2 | 8:00 | 2 |
| 108.7 | 103.3 | 116.8 | 128.1 | 132.7 | 131.6 | 128.3 | 107.4 | 86.5 | 13:45 | 2 |
| 60.8 | | 111.2 | 122.0 | 127.8 | 129.5 | 126.1 | 101.2 | 67.5 | 8:30 | 3 |
| 60.8 | | 121.5 | 124.7 | 123.0 | | | | | 8:45 | 3 |
| 62.4 | | 101.4 | 113.9 | 123.3 | 124.7 | 121.8 | 95.7 | 66.3 | 13:50 | 4 |
| 62.4 | | | 112.8 | 119.2 | 118.3 | | | | 13:59 | 4 |
| 68.2 | | 92.1 | 102.6 | 109.8 | 112.0 | 109.3 | 89.1 | 73.1 | 8:45 | 7 |
| 68.2 | | | 99.1 | 104.2 | 103.9 | | | | 9:00 | 7 |

TABLE 10
SBE mixed with Commercially-available SBE passivation product
(“Commercially Available”) temperature readings during Test 2.
Commercially Available - Temperature (° F.)

| | | | | | | | | | Sample | Days |
|---|---|---|---|---|---|---|---|---|---|---|
| Top | 0.5 ft | 1.0 ft | 1.5 ft | 2.0 ft | 2.5 ft | 3.0 ft | 4.0 ft | Bot | Time | After |
| 76.8 | | 159.5 | 162.7 | 161.5 | 162.5 | 156.5 | 130.5 | 83.0 | 7:45 | 1 |
| 76.8 | | 160.5 | 167.2 | 166.6 | 163.7 | 158.5 | 106.3 | 85.2 | 8:00 | 1 |
| 87.3 | | 161.1 | 168.8 | 167.3 | 161.5 | 148.3 | 105.4 | 82.9 | 8:25 | 2 |
| 87.3 | 130.2 | | 164.0 | 167.8 | 168.3 | | | | 8:40 | 2 |
| 115.2 | | 149.2 | 164.5 | 168.5 | 165.6 | 156.6 | 127.5 | 90.6 | 13:30 | 2 |
| 61.4 | | 142.0 | 161.8 | 170.0 | 169.5 | 162.8 | 127.5 | 70.4 | 8:00 | 3 |
| 61.4 | | 173.4 | 174.0 | 169.3 | | | | | 8:15 | 4 |
| 65.6 | | 138.8 | 153.8 | 165.0 | 165.8 | 158.4 | 122.4 | 71.2 | 13:11 | 4 |
| 65.6 | | | 169.3 | 172.4 | 168.5 | | | | 13:26 | 4 |
| 73.5 | | 116.8 | 135.6 | 146.5 | 150.1 | 144.1 | 110.1 | 78.1 | 8:00 | 7 |
| 73.5 | 132.0 | 175.5 | 171.2 | 162.4 | 156.5 | | | | 8:15 | 7 |

While there was no smoldering observed during Test 2, there was a large difference seen between the peak temperatures of SBE mixed with the commercially-available SBE passivation product and SBE mixed with sodium bicarbonate. The SBE mixed with sodium bicarbonate was consistently 32-63° F. lower over the course of several days. These results confirm that sodium bicarbonate deactivates the SBE better than the commercially-available SBE passivation product.

### Test 3: Use of Sodium Carbonate as a Means of Deactivating SBE

The following procedure was carried out for Test 3 with sodium carbonate:
1) Sodium carbonate was loaded into the commercially-available SBE passivation product silo.
2) An empty truck was placed under the ribbon blender for Train 1
3) 8% water and 6% sodium carbonate were the target amounts to add for Test 3
4) After the sodium carbonate addition, the mixture was mixed for about 10-15 min before dumping the ribbon blend into the truck below.
5) Once the truck was filled, it was placed on the South side of the tank farm wall.

The blend being fed to the unit for Test 3 was similar to the other tests, and the metals picked up by the bleaching earth are shown in Table 11:

TABLE 11
Metals pickup by the Bleaching Earth per train.

| PT Train 1 | Mg | Ca | Al | Na | K | P | Si | Fe | Total |
|---|---|---|---|---|---|---|---|---|---|
| Water Wash | 0.76 | 2.96 | 0.50 | 4.97 | 2.9 | 20.6 | 6.15 | 3.67 | 42.51 |
| Refined Oil | 0.85 | 1.91 | 0.5 | 5.88 | 1.27 | 4.81 | 3.84 | 1.45 | 20.51 |
| Metals Delta | — | 1.05 | — | — | 1.63 | 15.79 | 2.31 | 2.22 | 22.00 |

On the evening of Test 3, once the system was running steadily, an empty truck was brought under the ribbon blender of Train 1 and it was filled during the night. The sodium carbonate was able to flow through the system in the same way as the commercially-available SBE passivation product. Table 12 summarizes the sodium carbonate and water addition with the load cell readings.

TABLE 12
Sodium carbonate addition with the load cell readings.

| | | | | | | | | Addition (%) | |
|---|---|---|---|---|---|---|---|---|---|
| | | Ribbon Blender (lbs.) | | | Carbonate Feeder (lbs.) | | | Sodium | |
| Day | Time | Full | Empty | Delta | Full | Empty | Delta | Carbonate | Water |
| 1 | 15:25 | 3112 | 543 | 2569 | 241 | 84 | 157 | 6.1% | 8.5% |
| 1 | 16:10 | 3250 | 599 | 2651 | 241 | 84 | 157 | 5.9% | 8.6% |
| 1 | 16:55 | 3626 | 70 | 3556 | 241 | 85 | 156 | 4.4% | 7.1% |
| 1 | 17:40 | 2497 | 386 | 2111 | 239 | 83 | 156 | 7.4% | 8.3% |
| 1 | 18:35 | 3400 | 427 | 2973 | 237 | 82 | 155 | 5.2% | 8.0% |
| 1 | 19:11 | 3010 | 662 | 2348 | 240 | 85 | 155 | 6.6% | 9.0% |
| 1 | 19:50 | 3370 | 804 | 2566 | 240 | 83 | 157 | 6.1% | 9.2% |
| 1 | 20:30 | 3653 | 732 | 2921 | 237 | 81 | 156 | 5.3% | 8.8% |
| 1 | 21:12 | 3805 | 4 | 3801 | 240 | 86 | 154 | 4.1% | 7.0% |
| 1 | 21:58 | 2828 | 467 | 2361 | 237 | 82 | 155 | 6.6% | 8.4% |
| 1 | 22:40 | 3038 | 520 | 2518 | 240 | 82 | 158 | 6.3% | 8.4% |
| 1 | 23:17 | 2880 | 618 | 2262 | 238 | 83 | 155 | 6.9% | 8.9% |
| 1 | 23:57 | 3137 | 677 | 2460 | 238 | 84 | 154 | 6.3% | 8.9% |
| 2 | 00:38 | 3254 | 630 | 2624 | 240 | 86 | 154 | 5.9% | 8.7% |
| 2 | 01:15 | 3560 | 105 | 3455 | 241 | 84 | 157 | 4.5% | 7.2% |
| 2 | 02:05 | 2432 | 584 | 1848 | 240 | 83 | 157 | 8.5% | 9.2% |
| 2 | 02:40 | 2880 | 504 | 2376 | 241 | 84 | 157 | 6.6% | 8.5% |
| 2 | 03:25 | 3073 | 615 | 2458 | 240 | 85 | 155 | 6.3% | 8.8% |
| 2 | 04:23 | 3440 | 722 | 2718 | 243 | 87 | 156 | 5.7% | 8.9% |
| 2 | 04:50 | 3650 | 630 | 3020 | 239 | 83 | 156 | 5.2% | 8.5% |

| | | | | | | | | |
|---|---|---|---|---|---|---|---|---|
| Average | 3195 | 515 | 2680 | 240 | 84 | 156 | 6.0% | 8.4% |

During Test 3, there was no smoldering seen anywhere in the trailer, despite having temperatures in the low 90s and negligible cloud cover during the testing time.

During the 9 days following the addition of the sodium carbonate to the SBE, the temperature was taken in three locations at various depths as shown in Table 13. The initial temperature of the SBE was approximately 155° F. at the point of being dumped from the ribbon blender into the truck.

TABLE 13
Sodium carbonate temperature reading during Test 3.

| Sodium Carbonate Test | | | Temperatures (° F.) | | | | | |
|---|---|---|---|---|---|---|---|---|
| | | Location | | 1.5 | 2 | 2.5 | 3 | 3.5 |
| Time | Day | in Truck | Top | ft | ft. | ft. | ft. | ft. |
| 13:30 | Day 3 | Front | 146 | 136 | 144 | 148 | 149 | 145 |
| | | Mid | 140 | 140 | 148 | 150 | 148 | 141 |
| | | Back | 142 | 135 | 142 | 147 | 144 | 146 |
| | | Average | 143 | 137 | 145 | 148 | 147 | 144 |
| 11:00 | Day 7 | Front | 126 | 117 | 124 | 129 | 132 | 131 |
| | | Mid | 126 | 129 | 136 | 141 | 142 | 137 |
| | | Back | 125 | 118 | 127 | 137 | 140 | 139 |
| | | Average | 126 | 121 | 129 | 136 | 138 | 136 |
| 15:00 | Day 9 | Front | 120 | 118 | 122 | 126 | 126 | 123 |
| | | Mid | 120 | 125 | 131 | 134 | 132 | 126 |
| | | Back | 121 | 108 | 114 | 119 | 123 | 127 |
| | | Average | 120 | 117 | 122 | 126 | 127 | 125 |

The peak temperatures were seen near the mid-depth point and in the middle of the trailer, as expected. The temperatures steadily dropped over the 9-day period and averaged at approximately 3.5° F./day as shown in Table 14 below.

TABLE 14
Average Temperature Drop
Average Temperature Drop Over Time (°/day)

| | | | | | | Average |
|---|---|---|---|---|---|---|
| | 1.5 ft | 2 ft. | 2.5 ft. | 3 ft. | 3.5 ft. | Drop |
| Day 3 | 6.0 | 3.4 | 2.2 | 2.7 | 3.7 | 3.6 |
| Day 7 | 4.8 | 3.7 | 2.8 | 2.4 | 2.8 | 3.3 |
| Day 9 | 4.2 | 3.6 | 3.2 | 3.1 | 3.3 | 3.5 |

Test 3 demonstrated that, similar to sodium bicarbonate, sodium carbonate was able to deactivate the SBE, and also sodium carbonate worked in a warmer testing environment. During the 9-day testing period, the temperature of the SBE steadily dropped at 3.5° F./day despite the surface temperature roughly 45° F. higher than the ambient peak temperature (90° F.) during the day.

### ***

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A composition comprising an alkali metal salt and spent bleaching earth (SBE), wherein when the alkali metal salt contacts the SBE, the SBE is passivated.

2. The composition of claim 1, wherein the alkali metal salt is present in an amount from about 1.5 wt. % to about 7 wt. % compared to the total mass of the SBE.

3. The composition of claim 1, wherein the alkali metal salt is sodium bicarbonate.

4. The composition of claim 1, wherein the alkali metal salt is sodium carbonate.

5. A process for passivating SBE, the process comprising adding an alkali metal salt to the SBE, thereby passivating the SBE.

6. The process of claim 5, wherein the alkali metal salt is one or more of sodium bicarbonate and sodium carbonate.

7. The process of claim 5, wherein the alkali metal salt is provided as an alkali metal salt component, the alkali metal salt component comprising the alkali metal salt and one or more of soda ash, fly ash, talc, clay, an agricultural byproduct, corn cobs, rice hulls, wheat hulls, nut shells, saw dust, coconut husks, sand, silica, alumina, or clay.

8. The process of claim 5, wherein the alkali metal salt is added to the SBE as a dry powder.

9. The process of claim 5, wherein the alkali metal salt is added to the SBE as an aqueous solution or a slurry.

10. The process of claim 5, wherein the alkali metal salt is added in an amount from about 1.5 wt. % to about 7 wt. % compared to the total mass of the SBE.

11. A process for passivating SBE, the process comprising:
adding the SBE to a mixing apparatus,
adding an alkali metal salt to the SBE in the mixing apparatus, and
mixing the alkali metal salt and the SBE,
wherein when the alkali metal salt contacts the SBE, the SBE is passivated.

12. The process of claim 11, wherein the alkali metal salt is added to the SBE as a dry powder, an aqueous solution, or a slurry.

13. The process of claim 11, wherein the alkali metal salt is sodium bicarbonate.

14. The process of claim 11, wherein the alkali metal salt is sodium carbonate.

15. The process of claim 11, wherein the alkali metal salt is added in an amount from about 1.5 wt. % to about 7 wt. % compared to the total mass of the SBE.

16. A process for passivating SBE, the process comprising:
adding the SBE to a mixing apparatus;
adding an alkali metal salt component to water to form a slurry;
adding the slurry to the SBE in the mixing apparatus; and
mixing the slurry and the SBE,
wherein the alkali metal salt component comprises an alkali metal salt, and
wherein when the alkali metal salt contacts the SBE, the SBE is passivated.

17. The process of claim 16, wherein the alkali metal salt is sodium bicarbonate.

18. The process of claim 16, wherein the alkali metal salt is sodium carbonate.

19. The process of claim 16, wherein the alkali metal salt component is added in an amount such that the alkali metal salt is present from about 1.5 wt. % to about 7 wt. % compared to the total mass of the SBE.

20. The process of claim 16 wherein the alkali metal salt component further comprises one or more of soda ash, fly ash, talc, clay, an agricultural byproduct, corn cobs, rice hulls, wheat hulls, nut shells, saw dust, coconut husks, sand, silica, alumina, or clay.
